(19) United States
(12) Patent Application Publication
(10) Pub. No.: US 2025/0315886 A1
(43) Pub. Date: Oct. 9, 2025

(54) SYSTEM FOR MINTING AND MONETIZING OF A DIGITAL ASSET

(71) Applicant: Moran Biton, Natanya (IL)

(72) Inventor: Moran Biton, Natanya (IL)

(21) Appl. No.: 18/630,799

(22) Filed: Apr. 9, 2024

(51) Int. Cl. G06Q 40/04; G06Q 30/08

(52) U.S. Cl. CPC G06Q 40/04; G06Q 30/08

(57) ABSTRACT

A system and method for minting, trading, obtaining ownership, renting conducting NFT lotteries, running a business that provides utility NFT and airdrops of a physical product of a blueprint or other digital representation of a Part, Component, Product or Project or its associated rights developed on the basis of an idea, as a NFT via Blockchain Technology and Artificial Intelligence. The idea is given via three channels-upload ready blueprint; text, video, audio, or a combination of these data; and blueprint designed by user. The present invention aims to revolutionize the existing traditional product development procedure through ideation, development and validation. The NFT minted on the platform can further be categorized into Private and Public NFT. Further, the NFT can be minted as Main NFT, Physical NFT and Virtual NFT.

### TECHNICAL FIELD

The invention is a novel, unique and inventive method that relates to the field of minting of a product and more particularly to the field of minting, trading or obtaining ownership of a blueprint or a digital representation of a product and its associated rights as a non-fungible token using blockchain technology and artificial intelligence (AI).

### BACKGROUND

As of today, any product is developed using a time consuming heavy engineering mechanism that requires a heavy budget, manpower, and infrastructure. The existing product development process mainly involves following four stages: Ideation, Design, Validation, Production.

Ideation is when a concept or an idea emerges in the mind of a person. In the traditional product development process, Ideation is followed by the stage of “Designing” of the concept. The Designing process includes the following sub-stages:

### 1. Concept Design

The concept or the idea is designed based on the specifications of the final product. Multiple concept designs are made and the concept design that is near to the expected final product is approved.

### 2. Preliminary Design

A preliminary design of the chosen concept design is made. The preliminary design process includes the basic design calculation (that is generally done using excel sheet, programming, softwares, manual calculation et cetera).

### 3. Detailed Design

Once the Preliminary design is ready, the process then moves to the detailed design stage. The detailed design again requires detailed calculations and simulation (verification of the calculation), drafting of the manufacturing drawing.

After the detailed design is approved, the design specifications are confirmed. In other words, it is verified whether the design requirements of the product are fulfilled. The prototype of the product undergoes qualification testing. Based on the result, the design is eventually approved, verified and validated. This sums up the “Validation” process of the product development. Thereafter, the “Production” process begins. Similarly, the development of electronic hardware products also undergoes the process of designing the schematic diagram, designing printed circuit board (PCB), generation of the final bill of material (BOM) followed by testing, programming and debugging (if required). The traditional production method of a product requires machinery, equipment, man-power and infrastructure.

The invention, on the other hand, is a novel and innovative technology that culminates an idea into reality and also provides for monetizing the NFT without undergoing the time taking and costly procedure. The innovation only requires an internet connection and a compatible tool such as mobile, laptop, computer et cetera to convert an idea into an actual product. The invention facilitates the model-design process on the basis of Artificial Intelligence, smart automation and mints it as NFT using the Blockchain Technology.

Blockchain technology is a Distributed Ledger Technology (DLT) that involves the permanent recording of transactions on a distributed ledger system. Blockchain can be an avatar of real world assets (for example a token representing a bike) in the form of Non-fungible Token. NFT turns the digital assets to one of a kind by creating a unique digital signature. The invention also allows its users to sell the NFT design on the NFT marketplace and do transactions using crypto currencies.

There are few patent applications which provide a system of minting NFTs. In an example, the Patents KR102343025B1, US20210248214A1 disclose the system for minting NFTs using blockchain technology and artificial intelligence. However, these patents do not disclose the system for minting of a digital representation of a project, product, component or part of a physical product as a Non-Fungible Token (NFT) and the system of directly linking hardware (product and its associated rights) to their digital representation (digital asset). The present invention is a novel, innovative and breakthrough blockchain and AI based technology that has the potential to completely change the product development process and the way new inventions are realized.

The above background information provides context to the technical solutions proposed in this application. It is only to be used in understanding the technical solutions that are presented in this application. They do not in any way represent an admission of the above information as prior art.

### SUMMARY

In an aspect of the present disclosure, the invention specifically elucidates a system for the conversion of a digital blueprint and/or its associated rights into a Non-Fungible token (NFT). Further, the system provides for a platform where the NFT can be rented, traded or transferred and also a provides for NFT lotteries using block chain technology and artificial intelligence. The system aims to lead the Fourth industrial revolution by compressing into minutes the complex and expensive hardware development processes with an automatic and intuitive process that yields a complete blueprint. Further, the system serves as a tool to build an entire business, entity and corporation. This system employs methodologies such as artificial intelligence algorithms in the creation of the blueprint and blockchain technology in the minting and tokenization of the blueprint as a digital asset on a distributed ledger.

The system user can conveniently design a project, product, component, or part of a physical product, electronic equipment et cetera on his digital gadget such as mobile device, computer laptop by a mere description of it in the system (via three (3) different channels). The system facilitates convenient visualization of the 3D design model, the electronics circuit, the code and allows its users having basic understanding of technology to see electronic integration with mechanical design and functioning of code routines.

Based on the input (via three (3) channels) given by the user, the system generates a design-model based on the proprietary algorithms of the product, project, electronic equipment or other representation of an idea. The proprietary algorithm uses data that consists of the descriptions of the product and converts it into a design-model on the basis of the production formats of the file that are available on the platform. The design-model of a product consists of four layers i.e., Parts, Components, Product and Project.

The system converts the blueprint and/or digital representation of a product into a digital asset that can be stored, traded, manufactured, produced, patented or rented and also provide for NFT lotteries and in another ways be monetized. Thereafter, the blueprint is converted into a Non-Fungible Token on a blockchain network of its choice that is compatible with the system.

The NFT created on the platform is categorized as Private NFT and Public NFT. The creator of Private NFT has ownership rights whereas the ownership of Public NFT is with PCBIX Limited. Further, the NFT project can also includes customer quality verification. Also, the system mints a Main NFT, Physical NFT and Virtual NFT. The Main NFT consists of all the ownership rights, developed information, blueprint files, underlying codes and other crucial data related to the design-model. Further, the system user has the option of creating or buying Physical NFT and Virtual NFT. The Physical NFT can be used to manufacture a product and the Virtual NFT can be used in the digital world.

The owner(s) of the (Private) Main NFT has incorporated rights to mint a NFT physically or virtually. Physically means using the NFT for manufacturing purposes. Virtually means the right to use a NFT in the virtual world. Additionally, the owner of Main NFT can mint or sell or rent or provide for NFT lotteries or run a full-fledged company by interacting with investors, freelancers, customers, sales team and also provide for utility NFT and airdrops for the physical product so created. Physical NFT and/or Virtual NFT. Virtual NFT contains usage rights in virtual and/or other digital worlds including but not limited to the metaverse. Physical NFT grants the owner the proprietary rights to physically manufacture the product(s) associated with the Main NFT.

The owner(s) of the Main NFT, Virtual NFT and Physical NFT (Private NFT) can sell each NFT on the Platform or other compatible NFT trading platforms, at a fixed price or via an auction process. The transaction can be done in legal tender (e.g., USD), crypto currencies, digital currency etc.

The owner of the Main NFT and or the holder of the Physical NFT (Private NFT) can link their products with manufacturers registered or associated with PCBIX Limited with or without self-executing smart contracts. The platform also provides an opportunity for the Private NFT owner(s) to link their associated rights with the manufacturers directly.

This smart contract includes information such as confirmation, proof of ownership, intellectual property rights, terms and conditions, date and time stamp of the creation of the invention. It links the digital asset and it's associated NFTs.

### BRIEF DESCRIPTION OF FIGURES

Having thus described the invention in general terms, reference will now be made to the accompanying drawings, which are not necessarily drawn to scale, and wherein:

FIG. 1 is an overview of the generation of a digital blueprint process. As discussed above, the system user can give input to the system. The input is processed by the system, displayed to the user, and made available for download by the user in the preferred file format.

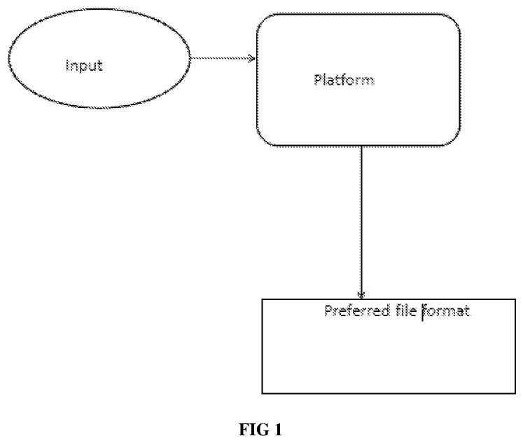

FIG. 2 is an overview of the classes of NFT. The NFT is categorized as 1) Public or 2) Private NFT.

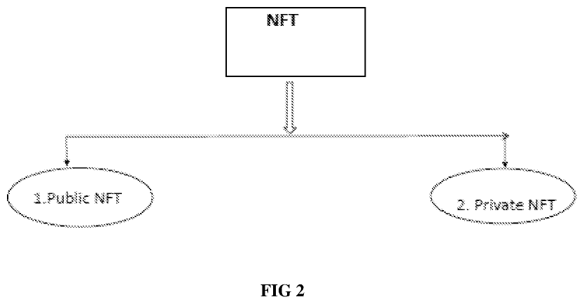

FIG. 3 is an overview of the generation of a digital blueprint by the system. As discussed above, the input can be given in any of the three (3) channels—i) by uploading the ready blueprint, ii) by giving description in the form of text, software, audio, visual formats, hardware, code, 3D design et cetera, and iii) designing and developing the blueprint on the platform. Based on the input given, the system can generate either one or all the 4 layers i.e., Part, Component, Product or Project. Following which, the output layer can be converted into its NFT.

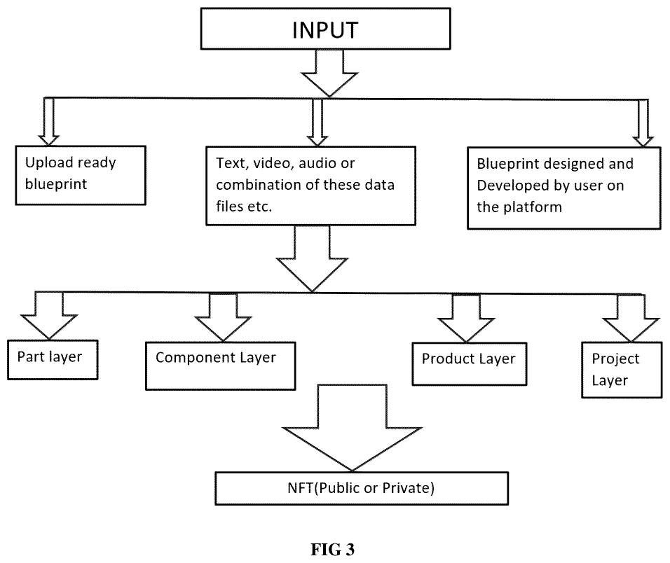

FIG. 4 is an overview of the Main NFT. The owner of the Main NFT can mint and sell Physical NFT and Virtual NFT.

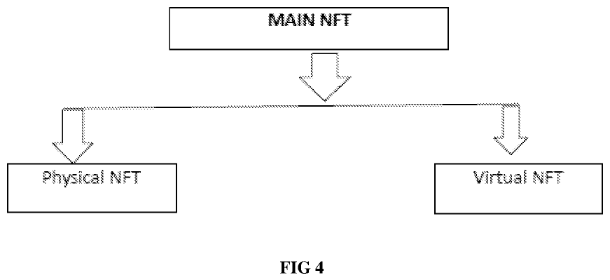

FIG. 5 is an overview of the process for the minting of the digital blueprint as a non-fungible token (NFT) on the blockchain. The digital blueprint is broadcast to the blockchain network as a transaction. A unique token is generated to represent this blueprint on the blockchain. The digital blueprint is represented as a block. The network nodes, through a hash process operation validate the transaction. The system user signs and verifies the transaction on MetaMask. The verified transaction is added to the previously processed blocks to form a chain. The transaction timestamp and transaction fees (gas) are recorded. The newly minted NFT is distinguished from other digital assets on the Blockchain through its unique hash address. This hash address attached to the NFT is further associated with the system user's individual wallet address.

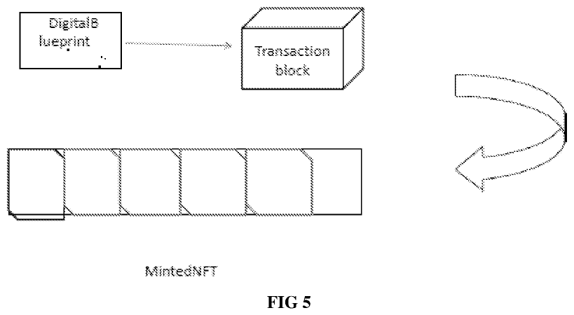

FIG. 6 outlines a flowchart for the commercialization of the digital blueprint and any other associated digital assets stored on the system user's wallet as digital assets as well as associated “physical” products. A request is made to the system user (Private NFT owner) on the platform for the licensing rights. The system user (Private NFT owner) reviews this request. If they do not agree to the terms, they can decline the request by responding “NO” on the Platform. If they accept the terms, they respond “YES” on the platform. The system user (NFT owner then certifies this response by signing it on their crypto wallet account. The licensing agreement smart contract is then automatically executed. The system user's assent is then recorded on the primary NFT owner's wallet address. This response accepting the licensing request is sent to the requestor.

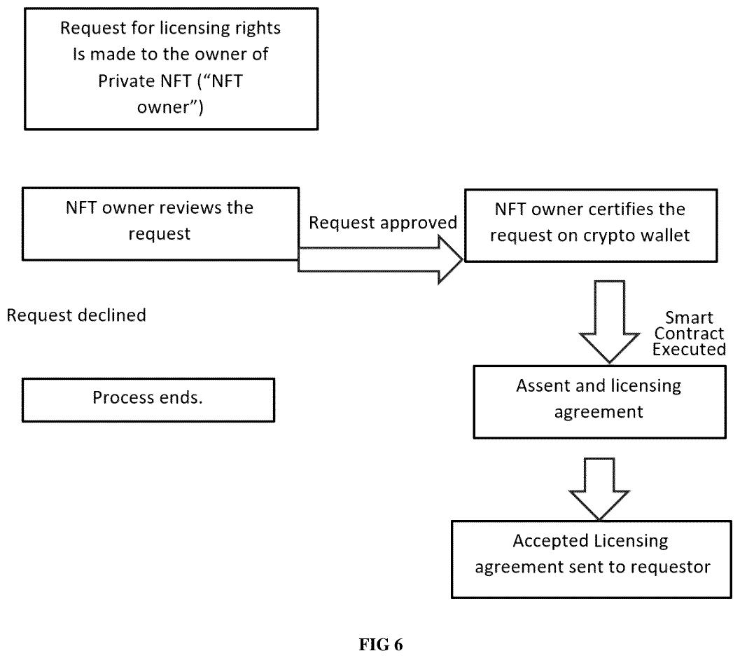

### DETAILED DESCRIPTION

In the following description, for purposes of explanation, numerous specific details are set forth in order to provide a thorough understanding of the present technology. It will be apparent, however, to one skilled in the art that the present technology may be practiced without these specific details. In other instances, structures and devices are shown in block diagram form only in order to avoid obscuring the present technology.

Reference in this specification to “one aspect” or “an aspect” means that a particular feature, structure, or characteristic described in connection with the aspect is included in at least one aspect of the present technology. The appearance of the phrase “in one aspect” in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but no other aspects.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

In an aspect of the present disclosure, the “system or platform” shall mean the web site or web app, mobile application or any other platform owned and controlled by PCBIX Limited i.e., the applicant in this PCT application. The system is a novel, unique and innovative process through which any physical product can be directly minted on the basis of input given by the user. The system user can give input in three (3) channels—i) by uploading the ready blueprint ii) by giving description in the form of text, software, audio, visual formats, hardware, code, 3D design et cetera iii) designing and developing the blueprint on the platform. The system also provides a platform using which an entire business can be developed. Moreover, the system is designed to be used and adopted by anyone with basic knowledge and skill, it does not require its users to possess specific technical or professional skills to use the platform.

The system user(s) also has the option to establish a full-fledged business including recruiting employees, having a sales team, interacting with investors, customer quality verification, employing freelancers using the platform and provide for utility NFT and airdrops for the physical product. The system user(s) can collaborate with the manufacturer on the platform itself for selling his/her product in the market. Furthermore, the system user can sell NFT virtually or digitally using the platform. Furthermore, the user can obtain ownership, rent, trade, and also provides for NFT lotteries. The system provides an end-to-end support in facilitating all these interactions using the blockchain technology and AI.

At present, the manufacturing sector is largely dependent on heavy machinery, engineers, technical experts, software programs, and costly infrastructure to execute the production process of a product. The designing phase itself undergoes a lengthy cycle as explained above. Needless to say that the existing manufacturing mechanism requires an enormous amount of time and professional expertise to realize an idea into reality. Whereas, on the other hand, the invention by eliminating and simplifying the Ideation, Development and Validation process is helping its users effortlessly, conveniently and expeditiously make an idea into a reality.

Further, the present invention makes the creation of design-model cost friendly for small entrepreneurs, innovators, tech-enthusiasts or anyone. The present invention merely requires an internet connection and a computer or mobile or any other compatible electronic device such as computer, laptop, mobile phones et cetera for minting of a blueprint and enables the owners of the blueprint to connect with the manufacturers.

The system comprises an innovative, unique and new process for conversion of an input given by the user into a design-model or blueprint and its associated rights such as IP rights, design of blueprint and any other functionality into a non-fungible token (NFT). The input can be given in the three (3) channels described above. “Design-model or blueprint or digital asset” mentioned here is a digital representation of the input given by the user or digital outcome of the description given by the user.

This system is a new and inventive process that employs methodologies such as artificial intelligence algorithms in the creation of the blueprint and blockchain technology in the minting and tokenization of the blueprint as a digital asset on a distributed ledger. The system user can make use of Artificial Intelligence to create a blueprint and or the digital representation of part, component, product or project by necessary input via the above mentioned three (3) channels. Depending on the format of the file that is uploaded on the platform, the data is converted into a design-model of a product, system, item or other representation of an idea or product using proprietary algorithms. In general, a proprietary algorithm is a sequence of steps or rules performed to achieve a specific action. Furthermore, the system can generate, through proprietary algorithms, a design-model for a product, system, item or other representation of an idea or product.

In an aspect of the present disclosure, after the user gets the blueprint or design-model with or without using proprietary algorithms, the blueprint or design-model is converted into a Non-Fungible token on a blockchain network of their choice that is compatible with the PCBIX Limited's network. The NFT token can be traded, rented and also the platform provides for NFT lotteries. In general, Non-fungible tokens (NFTs) are cryptographic assets on a blockchain with unique identification codes and metadata that distinguish them from each other. Every time a new design-model is created, a NFT is minted and it is called the Main NFT. The Main NFT includes ownership of the developed information, blueprint files, IP credentials, et cetera. A unique token is generated to represent this blueprint on the blockchain. Through a hash operation carried out on the blueprint, a unique hash address is also attached to the Main NFT which is its identifier and distinguishes it from other digital assets on the blockchain. The Main NFT hash address is broadcasted to the network. The network nodes verify the authenticity of this transaction. In the event of successful verification, this Main NFT is processed and recorded on the blockchain. The system allows the user to create a design-model in the existing project that gets associated with the Main NFT. For example, if the user has designed a model of drone and now wants to design a remote control of the same drone as a part of a project then the NFT of the remote control gets associated with the Main NFT of the drone.

The System is represented on the blockchain as the four (4) layers mentioned below. Further, the system allows each one of these layers to be minted as Main NFT.
Layer 1—Part Layer, which refers to constituent parts of products designed, manufactured and/or sold on the platform. In an illustration, electronic components like resistors, capacitors, inductors can be a part of the Part Layer mentioned above.
Layer 2—Component Layer, which refers to constituent components of products and/or systems designed, manufactured and/or sold on the platform. In an illustration, a Wi-Fi module, Bluetooth module et cetera can be a part of the component layer.
Layer 3—Product Layer, which refers to products that are designed, manufactured and/or sold on the platform. This layer also includes parts and components that are designed, manufactured and/or sold on the platform. In an illustration, a remote control, blueprint of a car, blueprint of a mobile device et cetera can be a part of this layer.
Layer 4—Project Layer, which refers to products, systems, frameworks, blueprints that are created, designed, edited, or otherwise altered, manufactured, or sold on the platform. The Project layer may include products that are designed, manufactured and/or sold on the platform. In an illustration, a remote control and a drone can form a part of the project layer.

These layers represent the hardware, physical products manufacturing and/or production, digital asset representation of the physical asset and the intellectual property and other proprietary rights associated with that digital asset. The system also provides an option for the user to create his own or buy NFT (private or public) of ready-made models from the other layers.

Two different types of NFTs can be minted at each layer of the system and those are: Private NFT, which is owned by its creator who is a private individual or a group of collaborating creators (co-owners). The Private NFT allows the user to create a design-model and to keep it for private use or invite collaborators to work on the existing design-model created by the user, these collaborators become the co-owners of the outcome. The owner of the private NFT is vested with the IP rights. Secondly, a Public NFT, which is owned by PCBIX Limited. The Intellectual Property rights of the Public NFT is with the PCBIX Limited. The royalty earned by such Public NFT is distributed amongst its creator and/or co-creators, PCBIX Limited and an exclusive customer group. The exclusive customer group are the clients of PCBIX Limited.

In the save mode, NFT minted is not shown in the marketplace. When the Main NFT is minted for a project, it is always in the save mode to facilitate future actions such as editing the existing design-model or selling it on the marketplace. Further, while minting Main NFT it automatically mints the Main NFT for the products associated with the project in the save mode. In the sale mode, the NFT is displayed on the marketplace. This gives the user to choose whether to display the NFT in the marketplace or to remove it from the marketplace if not purchased.

The Private NFT owner has three (3) modes to choose from: (i) Save mode—The Private NFT will automatically be saved on the platform. (ii) Share mode—The Private NFT owner has the option to share it on the platform. In share mode, the Private NFT becomes publicly visible. (iii) Sale mode—In the sale mode, the Private NFT owner has the option to either sell it on: (a) NFT Marketplace—by auctioning it on the NFT marketplace (b) Privately —by selling it privately to the other user(s). If the Private NFT is sold, then its owner(s) will automatically receive a fixed % of the shares in the revenue (royalties), transferred to its crypto wallet address from the said transaction and/or other commercialization of any NFT minted on the Platform. The IP rights of the Private NFT are with the respective owner/co-owners of the Private NFT. (c) Run a full-fledged business by recruiting employees, interacting with investors, sales professionals and providing for utility NFT and airdrops for the physical product using blockchain technology and AI.

The Public NFT creator has three (3) modes: (i) Save mode—The Public NFT will be saved automatically on the platform. (ii) Share mode—The Public NFT creator has the option to make it publicly visible by sharing it. (iii) Sale mode: In Sale mode, the Public NFT creator: (a) has the option to sell it on NFT Marketplace (b) the NFT will automatically become available for selling privately i.e., to other user(s). The Public NFT is automatically saved and is always visible to other users for private sale. The royalty received from selling the Public NFT is distributed amongst its creator or co-creator, PCBIX Limited and its exclusive customer group. The intellectual property rights of the Public NFT are with the PCBIX Limited.

The owner(s) of the Main NFT can mint and/or sell two other types of NFTs as well i.e., Virtual NFT and Physical NFT. Firstly, a Virtual NFT, which contains usage rights in virtual and/or other digital worlds including but not limited to the metaverse. Secondly, a Physical NFT, which grants the owner of the Physical NFT proprietary rights to physically manufacture the product(s) associated with the Main NFT. The owner(s) of the Virtual NFT can sell it on the platform at a fixed price or via an auction process on the NFT marketplace. The system or the Platform also provides the option of using the Virtual and Physical NFT for private use apart from commercializing it.

The collaboration between the creators of NFTs on the platform, inter alia, includes updating, developing, and improving the developed Layer, that is Project, Product, Component and/or Part (fractional NFT). The ownership of the blueprint is recorded on a smart contract. The creators and/or contributors to the design-model associated with the NFT may purchase or be assigned shares sold or relinquished by other creators and/or collaborators to the co-owners. All changes in ownership of the NFTs are similarly recorded on a smart contract. Defining and transferring profits to PCBIX Limited from sales (royalties) are an integral part of the smart contract. In Private NFT, all collaborators are entitled to ownership shares in the respective NFT. In the case of Public NFT, the creator or co-creator has the right to receive a certain % of royalty. The IP rights of Public NFT are with PCBIX Limited. Further, PCBIX Limited and its exclusive customer group also have the right to claim royalty at a certain rate.

Proof of ownership of these intellectual property rights associated with the Layer and associated foundational product can be added to the blockchain transaction by uploading the registration document, for example—a registered patent certificate on the Main NFT by signing a transaction. The Main NFT and its ledger of transactions are therefore represented on the blockchain as bundled digital assets and rights.

The owners of the Main NFT can, during the development of each layer and minting of the corresponding Main NFT, also create or purchase Private and/or Public NFTs minted on other layers of the system, including those that represent readymade Project, Product, Component and/or Part models. The owner of the Main NFT can delete any NFT if he is the only owner. For a Private NFT to be deleted, the associated virtual or physical NFT should not be sold otherwise, the owner along with the co-owners has the right to delete the Private NFT. If the NFT is sold then it cannot be deleted by the owner as he now has no rights on the NFT. In an illustration, if the user has a project of a car—and the user sold the virtual NFT of the car and/or window of the car that they mint as part/component. If the user now wants to delete the car he cannot delete the Virtual NFT and the window part as it is already sold. Whereas, the Public NFT can only be deleted by the PCBIX (Israel) Limited. The system or platform includes a process to prevent replication of the design-models as the PCBIX Limited has the rights to delete any design-model that is a replication of an existing one.

In another aspect of the present disclosure, it is not possible to buy the NFT of a single product of the project, the entire main NFT of the project has to be bought. When a user buys a virtual NFT, he/she can use it virtually such as using it in metaverse and for other purposes. If a physical NFT is bought, it can be used for generating or manufacturing the physical version/product of the said NFT.

Additionally, the invention also serves as a “platform as a service” (PaaS). It provides the users an option to sell, trade, rent and monetize the NFT in any form and provide for NFT lotteries. Similarly, a buyer has the option to participate in an auction or buy an NFT. The system can make use of Artificial Intelligence and Blockchain technology to facilitate trading processes within the NFT marketplace whereas in general, it takes a long time for an idea to enter the commercial market.

Further, the existing methods do not provide a solution for conversion of an idea into a full fledged business model using a single platform. Whereas the invention is a model, that gives its users the option to collaborate with other users to convert an idea into a venture and/or a full fledged corporation. Besides, the invention also facilitates transactions to be made in various forms including blockchain based crypto currency, digital currency, legal tender etc.

The foregoing descriptions of specific aspects of the present technology have been presented for purposes of illustration and description. They are not intended to be exhaustive or to limit the present technology to the precise forms disclosed, and obviously many modifications and variations are possible in light of the above teaching. The aspects were chosen and described in order to best explain the principles of the present technology and its practical application, to thereby enable others skilled in the art to best utilize the present technology and various aspects with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology. While several possible aspects of the invention have been described above and illustrated in some cases, it should be interpreted and understood as to have been presented only by way of illustration and example, but not by limitation. Thus, the breadth and scope of a preferred aspect should not be limited by any of the above-described exemplary aspects.

1. A method comprising a system for the conversion of a blueprint and/or other digital representation of a product, project, component, or part of a physical product on the research and development platform, into a non-fungible token (NFT) that is recorded on a distributed ledger (blockchain) that can be stored, traded, manufactured, produced, patented or rented and also provides for NFT lotteries and in any other ways be monetized.

2. The method according to claim 1, wherein the system further comprises a method for conversion of an input into a product blueprint and/or other digital representation of a product, project, component, or part of a physical product on the research and development platform, through a proprietary algorithm/artificial intelligence system. The blueprint and/or digital representation of a product, component, or part of a physical product is then minted on a distributed ledger (blockchain) as a non-fungible token.

3. A method for the minting of Non-Fungible token that represents layers of the system, namely the Part Layer (Layer 1), Component Layer (Layer 2), Product (Layer 3), Project Layer (Layer 4) wherein the Layers are hierarchical.

4. The method according to claim 3, wherein the system classifies a NFT, into two categories: Firstly, a Private NFT, which is owned by the user-who is a private individual, or a group of collaborating users (co-owners); The IP rights are vested with the owner or co-owners; Secondly, a Public NFT, which is owned by PCBIX Limited; The company (PCBIX Limited) is vested with the IP rights; The royalty from a Public NFT will be shared amongst the creators and/or the co-creators, PCBIX Limited and the exclusive customer group.

5. The method according to claim 4, wherein the system further comprises the minting of two other types of NFTs on the Main NFT, wherein The Main NFT holder has all the rights incorporated therein; A Main NFT holder can also use it physically and virtually. “Physically” means using the NFT for manufacturing processes and “virtual use” gives the right to use the NFT in the digital/virtual world; and the Main NFT holder has the option to mint Physical NFTs and Virtual NFTs and store, trade, manufacture, produce, patent or rent and also provides for NFT lotteries and in any other ways be monetized.

6. Virtual NFT contains usage rights in virtual and/or other digital worlds, including but not limited to the metaverse; and The Physical NFT grants the proprietary rights to physically manufacture the product(s).

7. The method according to claim 3, wherein the system, further comprises smart contracts which automatically and permanently records the information such as confirmation, proof of ownership, Intellectual property rights, terms and conditions, date, and time stamp of the creation of the invention and linkage between the asset and associated NFTs minted on the platform.

8. The method according to claim 3 to which the system provides a platform where one or more creators can create a product individually or together using blockchain technology and artificial intelligence, the system provides an option to build an entire full-fledged business wherein a company is created that holds the IP rights, collaborates with freelancers, sales team, attaining partnerships, employing employees using the platform and Further, can provide for utility NFT and airdrops for the physical product.

9. The system, which according to claim 3, wherein the system further comprises smart contracts facilitates the transfer a fixed % of the share in the revenue (royalties) to its wallet address, from the sale and/or other commercialization of Public and Private NFT minted on the platform to PCBIX Limited's crypto currency wallet address.
